(19) United States
(12) Patent Application Publication
(10) Pub. No.: US 2023/0153824 A1
(43) Pub. Date: May 18, 2023

(54) SYSTEMS AND METHODS FOR DISTRIBUTED REFUND PROCESSING

(71) Applicants: Jared Adam Paris, Durham, NC (US); Clayton James Stewart, Durham, NC (US)

(72) Inventors: Jared Adam Paris, Durham, NC (US); Clayton James Stewart, Durham, NC (US)

(21) Appl. No.: 18/099,968

(22) Filed: Jan. 22, 2023

Related U.S. Application Data
(63) Continuation of application No. 16/930,256, filed on Jul. 15, 2020, now abandoned.
(60) Provisional application No. 62/874,425, filed on Jul. 15, 2019.

(51) Int. Cl. G06Q 20/40; G06Q 40/04; G06Q 20/02; G06Q 20/36; G06Q 20/20; G06Q 20/06

(52) U.S. Cl. CPC G06Q 20/407; G06Q 40/04; G06Q 20/02; G06Q 20/3678; G06Q 20/202; G06Q 20/065

(57) ABSTRACT

A network-connected, electronic refund processing system encourages household saving by enabling consumers to receive a card payment refund in forms other than the conventional method of crediting the consumer's account with fiat currency. The enhanced refund processing system connects legacy payment/refund systems to distributed stored value systems such as virtual currency wallets, and to systems for recording ownership of other financial assets such as commercial paper and securities. In exemplary embodiments, the consumer can choose to receive refunds in the form of various non-cash financial assets, including virtual currencies, and more specifically cryptocurrencies such as Bitcoin, ether and Litecoin; commercial paper (loans, contracts, forms and others); and securities (stocks, bonds, derivatives, and other financial assets).

This application claims the benefit of U.S. provisional patent application Ser. No. 62/874,425 filed Jul. 15, 2019, the entire specification of which is incorporated herein by reference.

### TECHNICAL FIELD

The present invention relates generally to electronic systems and methods for processing consumer refunds for purchases and for simplified acquisition of non-cash representations of value, via a distributed network.

### BACKGROUND ART

Virtual currencies (including cryptocurrencies) are gaining increasing recognition as stores of value that can be used to facilitate transactions. These alternative currencies are typically implemented using a blockchain, which provides a distributed ledger that can record transactions between two parties efficiently, verifiably, and permanently. Virtual currency blockchains are typically managed by a peer-to-peer network following an agreed protocol for communication between nodes and for validating new blocks.

Functional connections between distributed networks that implement virtual currency transactions, and traditional banking systems that implement fiat currency transactions such as merchant payment systems, as well as connections of these systems to systems for buying and selling securities, presently offer only a limited scope of connectivity and limited transactional features.

In the prior art, when a customer requests a refund from a Merchant, the customer is typically offered a refund in the form of store credits, chargeback on a Credit Card, cash, or fiat currency returned to their chosen bank account.

Some merchants now allow customers to make purchases with virtual currency through various merchant processors which convert the virtual currency payment into a fiat payment of the merchant's choosing. When a customer wishes to receive a refund, the refund is typically in the form of fiat or store credit.

This forces customers who may have paid in virtual currency to receive a refund in fiat currency and then pay additional fees to convert fiat back into virtual currency. There is no ready solution to this obstacle in the prior art; any merchant that wanted to offer refunds in non-fiat currencies would have to hold a volatile asset, transfer the fiat-denominated refund into a non-fiat currency, ensure regulatory compliance for the refunds (including anti-money-laundering, know your customer compliance), as well as complying with regulations applying to the transfer of other non-fiat stores of value that might be involved.

A further obstacle arises from credit card issuer requirements that the merchant must issue any refunds to the same credit card used to make the purchase, to recoup processing fees for the transaction.

The inventors have identified additional obstacles that must be overcome in order to achieve their vision for new types of transactions and financial exchanges that will benefit consumers and especially consumer savings patterns.

In the 1980's, British retail store Tesco introduced this concept of “Cash Back” allowing customers to conveniently make a cash withdrawal from their checking account while completing a purchase with their debit card, rather than paying for their purchases and then obtaining the desired cash in a separate transaction at an ATM. Today, many merchants offer this “cash back” option during a bank debit purchase transaction. However, the inventors have noted that available payment systems do not allow customers to acquire an alternative currency (as opposed to “cash back”) as part of a payment transaction.

Instead, consumers who want to purchase virtual currencies, such as cryptocurrencies, without going through an online exchange typically use virtual currency ATMs, paying fees ranging from 6% to 20% of the purchase value, or buy the virtual currency in a peer-to-peer transaction. These mechanisms for offline purchase of alternative currencies have deficiencies; the consumer is forced to choose between paying significant transaction fees at a virtual currency ATM, or risking robbery, scams, or regulatory compliance issues while conducting a purchase transaction with a stranger.

The inventors have therefore determined that there is a need for technological improvements to provide enhanced transactional options for consumers. The inventors have further determined that this broad need for improvement encompasses a more specific need for new systems that can process payments and refunds using disparate mechanisms to enable new categories of business and savings transactions. There is also a need for a system that can process payments and return non-cash measures of value (such as virtual currency) to the consumer as part of the transaction.

### BRIEF DESCRIPTION OF THE DRAWINGS

The accompanying drawings, which are incorporated herein and form a part of the specification, illustrate various exemplary embodiments of the present invention and, together with the description, further serve to explain various principles and to enable a person skilled in the pertinent art to make and use the invention.

FIG. 1 is a block schematic diagram showing an exemplary interconnection of merchant systems with an exemplary embodiment of a novel refund marketplace to process consumer refunds in virtual currency, commercial paper, or securities, which also facilitates alt-value purchases during processing of a sale;

FIG. 2 is a data flow diagram illustrating an embodiment of a process for transmitting refunds via a multifunctional refund marketplace where refunds can be received in other forms such as virtual currency, commercial paper, and securities;

FIG. 3 is a block schematic diagram showing an exemplary interconnection of merchant systems with an example embodiment of a novel refund marketplace, to process consumer refunds in virtual currency, commercial paper, or securities including interaction with a credit card processor; and

FIG. 4 is a data flow diagram illustrating an embodiment of a process for transmitting refunds via a multifunctional refund marketplace where card payment refunds can be received in other forms such as cryptocurrency, commercial paper, and securities, and which also facilitates alt-value purchases during processing of a sale.

### BEST MODE FOR CARRYING OUT THE INVENTION

The present invention will be described in terms of one or more examples, with reference to the accompanying drawings.

The present invention will also be explained in terms of exemplary embodiments. This specification discloses one or more embodiments that incorporate the features of this invention. The disclosure herein will provide examples of embodiments, including examples from which those skilled in the art will appreciate various novel approaches and features developed by the inventors. These various novel approaches and features, as they may appear herein, may be used individually, or in combination with each other as desired.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, persons skilled in the art may implement such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors, typically distributed in a network. A machine-readable medium may include any mechanism for storing or transmitting information in a form readable by a machine (e.g. a computing device). For example, a machine-readable medium may include read only memory (ROM); random access memory (RAM); hardware memory in handheld computers, tablets, smart phones, and other portable devices; magnetic disk storage media; optical storage media; flash memory devices; electrical, optical, acoustical, or other forms of propagated signals (e.g. carrier waves, infrared signals, digital signals, analog signals, etc.), Internet cloud storage, and others. Further, firmware, software, routines, instructions, may be described herein as performing certain actions. However, it should be appreciated that such descriptions are merely for convenience and that such actions in fact result from computing devices, processors, controllers or other devices executing the firmware, software, routines, instructions, etc.

An example embodiment of the present invention provides improved electronic systems, network arrangements, and improved processing methods for transmitting and creating stored value for a consumer who is receiving a refund, in forms other than crediting the consumer's account with an amount of fiat currency. These alternative forms of establishing refund value may include any element of value that is not denominated in fiat currency; in the example embodiment the consumer can choose to receive refunds in the form of various other non-cash financial assets such as virtual currency, commercial paper, and securities.

In an embodiment, a customer is provided with the option to obtain a refund for a purchase by interacting with an agent of the merchant. In this example embodiment, the existing payment infrastructure is modified to provide an interface to an enhanced refund processing system. The enhanced refund processing system, which may be referenced herein as a “refund marketplace,” provides a variety of operational features and serves as a gateway to connect legacy payment/refund systems to distributed stored value systems such as virtual currency wallets, and to systems for recording ownership of other financial assets such as commercial paper and securities.

As non-limiting examples, the consumer may be offered refunds in the form of various non-fiat currencies, including virtual currencies and cryptocurrencies (bitcoin, ether, litecoin, etc.), commercial paper (loans, contracts, forms, etc.), and securities (stocks, bonds, derivatives, and other financial assets).

In some embodiments, the agent for the merchant that provides this enhanced interface and the accompanying refund options may be the merchant processor or the merchant itself, while in other embodiments, the agent may be a separate entity distinct from the merchant and the merchant processor.

The customer may be made aware of the availability of the merchant agent process through any of the existing payment processing entities, or through a separate outside party, for example, by the use of a logo symbolizing the process. The refund request may be initiated by a phone call, cellular text message, internet message, interactive web page, or a Point of Sale system.

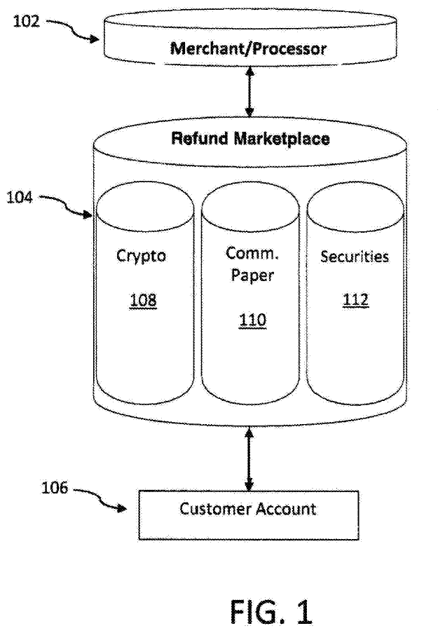

FIG. 1 is a block schematic diagram illustrating an example embodiment of an interconnected system that enables electronic transmission of a refund. The elements of the system are preferably electronically interconnected, such as by a public data network like the Internet, or a private network. In this structure, the refund instruction and associated data flows generally from a Merchant/Merchant Processor 102 to a connected refund marketplace 104 and then into a Customer Account 106 connected to the refund marketplace. Refund marketplace 104 may provide access to refunds in multiple forms, for example, virtual currencies (such as cryptocurrencies) 108, commercial paper 110, and securities 112.

In the example embodiment of FIG. 1, the customer account 106 may include a virtual currency wallet, and/or a customer profile for holding commercial paper or securities. Although shown for simplicity as a single account location, the system shown is preferably set up to access a variety of customer accounts 106 maintained by other organizations. Such accounts are typically maintained by storing records of the accounts on servers operated by the organization maintaining the account. For example, cryptocurrency wallets represent “accounts” that can be created and maintained by cryptocurrency exchanges, other service providers, or by individuals. Brokerage, financial, and commodity accounts are typically established and maintained for a consumer by brokers and other organizations legally qualified under applicable regulations and holding the required licenses to provide those accounts and services to consumers. Refund marketplace 104 is preferably connected to a plurality of customer accounts, including those described herein, and other types and sources of accounts that presently exist or may be developed in the future.

In an embodiment, merchant or merchant processor 102 is implemented in software and operates on one or more servers connected to a network such as the internet. merchant/merchant processor 102 is electronically connected to one or more live point-of-sale systems, online sales systems, and/or other purchase-enabling interfaces. Merchant processor 102 uses these connections and its internal programming to perform conventional merchant payment processing functions when customers wish to pay for goods or services or obtain a refund for a previous purchase. Merchant processor 102 is further provided with an interface that receives both refund requests and alternative value purchase requests from a merchant point of sale or other merchant system, when such requests are initiated by the customer, allows the customer to specify the form of a refund or purchase, and transmits relevant instructions and data to the refund marketplace 104 to process the customer request.

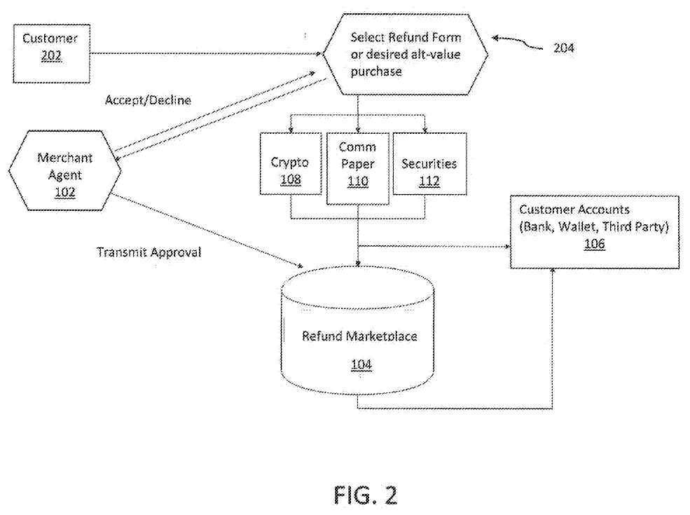

FIG. 2 is a data flow diagram showing the transaction flow for a refund issued in an example embodiment, or for a purchase of non-fiat value executed as part of a merchant purchase transaction.

In the case of a refund, initially, the customer 202 requests a refund from a merchant, and the merchant will then accept or deny the refund request, such as via merchant agent 102. If the refund request is denied, the process stops there. If the refund request is accepted, customer 202 will be shown additional options to receive a refund in a non-fiat store of value, as shown in step 204. Once the customer selects the desired mechanism for the refund (examples illustrated in FIG. 2 include virtual currencies such as crypto 108, commercial paper 110, and securities 112), they will also have the opportunity to log-in to their non-fiat account such as a brokerage or cryptocurrency exchange account, give a wallet ID to facilitate a virtual currency transaction, or otherwise facilitate the desired transfer of value to an account belonging to the customer 202. In this example embodiment, a merchant agent 102 transmits approval and the fiat value to refund marketplace 104. Refund marketplace 104 converts the amount of the refund to the non-fiat value that the customer 202 selected and transmits it to the appropriate consumer account 106.

Refund marketplace 104 is preferably implemented in a centralized server or a distributed set of servers, operably connected to a communications network such as the internet. This server or servers provide an operational interface between (on the one hand) consumer devices, point of sale systems, online merchant systems, and other systems capable of initiating refund transactions, and (on the other hand) systems that maintain accounts and records of consumer assets, including for example systems that enable virtual currency wallets, systems that record holdings of commercial paper, and systems that record securities holdings.

In an alternative embodiment, the refund marketplace is implemented as a more broadly distributed processing system where distributed nodes operated by merchants or transaction processors can initiate refund transactions, with a record of each transaction permanently stored in a blockchain.

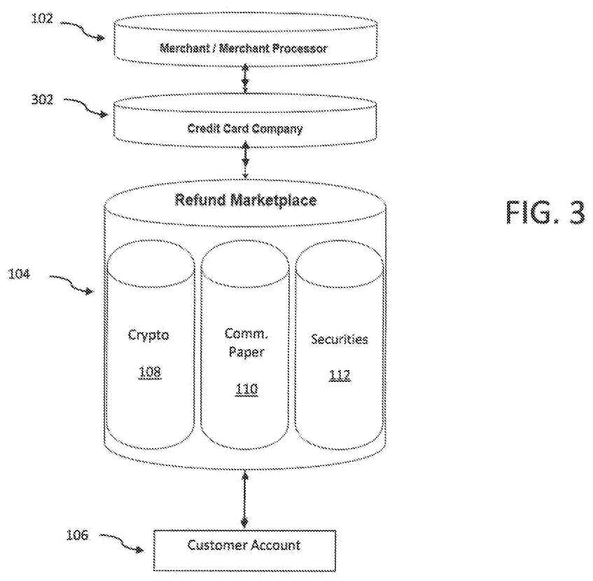

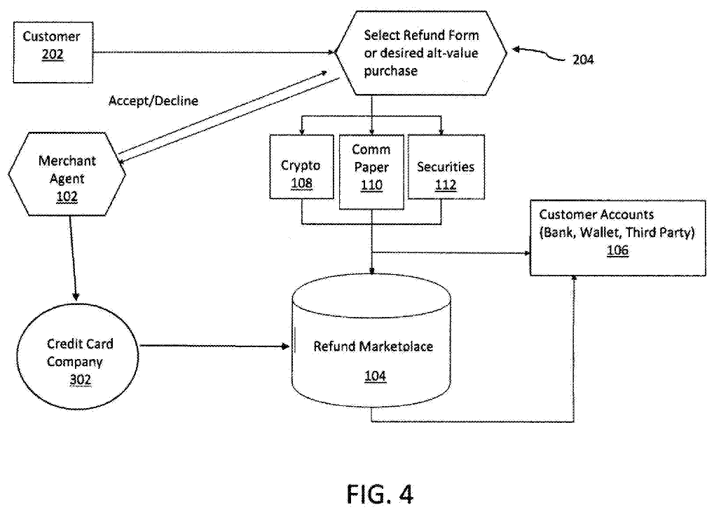

FIGS. 3 and 4 illustrate a modification of FIGS. 1 and 2 according to an alternate embodiment wherein a credit card issuer is a party to the refund process to enable compliance with the issuer's requirements. Where required, the refund may be sent to a credit card issuer for processing, with the amount then sent to the refund marketplace as directed by the consumer.

FIG. 3 shows an interaction of discrete systems wherein the refund is transmitted from a merchant/merchant processor 102 to a credit card processor 302, and then to refund marketplace 104 and into a customer account 106. Refund marketplace 104 may provide access to refunds in multiple forms, for example, virtual currencies 108, commercial paper 110, and securities 112. In the example embodiment of FIG. 3, the customer account 106 may include a virtual currency wallet 108, and/or a customer profile for holding commercial paper 110 or securities 112.

FIG. 4 includes generally the same data flows, sources, and destinations shown in FIG. 2, with the addition of credit card issuer 302 that, in the embodiment of FIG. 4, receives the refund authorization and fiat value from the merchant agent 102 and transmits the value to refund marketplace 104 for conversion into the desired form of value and delivery to customer account 106.

The following functional examples illustrate various advantages of the systems and methods disclosed herein that can be implemented and realized in specific embodiments.

The systems and methods disclosed herein provide an opportunity for consumers to increase their savings (effectively make investments) in small amounts that they feel they can do without. For example, a customer who may have made an impulse purchase can opt to “invest” the refund instead of receiving fiat back. This allows for those who need to invest the most (impulsive buyers) to elect to start investing and build up a portfolio throughout one's lifetime. Consider a consumer who bought Bose QuietComfort 35 headphones as an impulse purchase for $349.00, then returned them on Jan. 1, 2019. If this consumer felt that he did not need a cash refund to facilitate other purchases, and elected to receive his refund in BTC, according to Coin Market Cap, the consumer would have received back around 0.09 BTC. As of Jul. 8, 2019, 0.09 BTC would be valued at $1,105.99, which is over three times the amount of the original refund. Thus, this consumer would have added to his savings and may also profit from appreciation of an investment asset.

In an embodiment, a consumer's preferred mechanism for receiving refunds may be stored and established as that consumer's default mechanism by merchant/merchant processors.

In some embodiments, the consumer may elect their desired mechanism for the refund on a web page, or at a point-of-sale interface.

In an embodiment, the consumer is provided with the option of exchanging part, rather than all, of the refund due into other assets via the refund marketplace. As an example, if the consumer returns a pair ofjeans, for credit of $50.00, the consumer may elect to take 50% or $25.00 in cryptocurrency, with remainder of the refund made in the merchant's standard refund form (such as store credit, cash, or debit).

In another embodiment, limits are placed on the amount of any refund processed through the refund marketplace. For example, a minimum amount for processing, such as $10.00, can be imposed and there may be a maximum permitted amount for alternative refund, such as $500.

In an embodiment, the consumer may use third party services such as Cash App or Coinbase for the transaction of fiat to virtual currency. However, it should be appreciated that any appropriate mechanism can be used for the transmission of value to the refund marketplace for application to the consumer's accounts in various forms, including virtual currency, commercial paper, securities, and other desired alternatives.

In an embodiment, the refund marketplace charges a fee to the consumer. As an example, the fee may be a percentage of the refund processed. The refund marketplace may also profit by collecting referral fees, joint marketing commissions, and other amounts paid by third party vendors whose services are used in the refund process. For example, if a customer signs up for the Cash App in order to receive the refund, the refund marketplace may receive compensation from the Cash App operator for providing a new customer.

The fees charged, and the basis for calculating fees, can be varied as desired or even entirely eliminated, all within the scope of the invention. In one example, the refund marketplace charges a 10% fee for processing the refund and storing it in the desired asset. In this example, ninety percent of the amount returned would be deposited in a virtual currency wallet, or in a commercial paper or securities account. The 10% fee is this example is received by the refund marketplace. In an embodiment, Merchants and/or Credit Card Processors are paid a portion of this processing fee charged by the refund marketplace. In particular, payments from the fees collected may be distributed to the merchant, merchant processor, and other participants in the transaction as agreed between the parties involved. These payments may enable merchants to forego reimbursement of processing fees paid on the now-refunded transaction, without incurring financial hardship.

If the Merchant receives an alternative currency for the transaction and elects to issue refunds in the same non-fiat currency, the system disclosed herein can still offer a range of other refund mechanisms to that consumer, including other virtual currencies, commercial paper, and securities.

In addition to enabling purchase refunds in various non-fiat forms, in preferred embodiments, the present invention and the operating features of the refund marketplace computing devices allow consumers to purchase an alt-value such as a virtual currency in a linked transaction during a merchant purchase. In a preferred embodiment, during the process of paying a merchant (such as with a debit or credit card), the customer is given the option to purchase an alternative currency or other value at the point of sale by interacting with an agent of the merchant.

Referring again to FIGS. 2 and 4, in order to offer this option to customer 202, customer 202 is asked during checkout if they wish to make an alt-value purchase. In an embodiment, the optional alt-value purchase offer is made at the payment terminal; for example, the payment terminal may invite the customer to indicate whether they want cash back, and then invite the customer to indicate whether they want to make a separate alt-value purchase during processing of their payment to the merchant. An example offer of an alt-value purchase is implemented in step 204 in FIGS. 2 and 4. Provided that the customer has a sufficient credit or debit balance to make the requested alt-value purchase, merchant agent 102 will obtain approval for the alt-value purchase and transmit funds for the purchase to refund marketplace 104. In the example embodiment, the conversion by the refund marketplace of a refund to non-fiat assets, and the conversion of an additional debit request to non-fiat assets, are performed in a substantially similar manner. Generally, merchant agent 102 sends approval and the funds to pay for the desired alt-asset to the refund marketplace 104. Refund marketplace 104 obtains the desired asset and delivers it to the customer account 106. Whether the source of the purchase funding was a refund or an additional debit, the customer account 106 then contains the additional asset desired by the customer 202.

In exemplary embodiments, the process disclosed herein provides consumers with the option to authorize an additional debit to their financial account as part of a purchase transaction, for the purpose of purchasing a specified amount of alternative currency as part of the purchase transaction.

This added functional option preferably uses the existing payment infrastructure, processing a second debit transaction for the customer in addition to the debit from the customer's account to pay for goods or services. In requesting this optional second transaction, the customer can opt to receive various non-fiat values, such as virtual currencies including cryptocurrencies (for example, bitcoin, ether, litecoin, and others), commercial paper (loans, contracts, forms, and other), and securities (stocks, bonds, derivatives, and others). The functionality provided in these embodiments offer the customer financial options and convenience well beyond traditional cash-back transactions offered by merchants.

In some specific applications, the agent of the merchant for providing the customer with an alternative value purchase transaction as part of their payment transaction may be the merchant processor or the merchant itself, while in other applications, the agent may be a separate entity distinct from the merchant and the merchant processor.

The customer may be made aware of the availability of the merchant agent process through any of the existing payment processing entities, or through a separate outside party, for example, by the use of a logo symbolizing the process. The refund request may be initiated by a phone call, cellular text message, internet message, interactive web page, or a Point of Sale system.

Although illustrative embodiments have been described herein in detail, it should be noted and understood that the descriptions and drawings have been provided for purposes of illustration only and that other variations both in form and detail can be added thereto without departing from the spirit and scope of the invention. The terms and expressions in this disclosure have been used as terms of description and not terms of limitation. Thus, the breadth and scope of the present invention should not be limited by any of the above-described exemplary embodiments but should be defined only in accordance with the claims and their equivalents. The terms and expressions herein should not be interpreted to exclude any equivalents of features shown and described, or portions thereof.

1-16. (canceled)

17. A process for electronically processing refunds from a plurality of participating merchants to a customer, comprising the steps of:
a. providing an electronic enhanced refund processing server, connected via a data transmission network to a merchant transaction server that processes customer transactions for at least one merchant;
b. providing the customer with access to an electronic interface of the enhanced refund processing server, accessible via a data transmission network, wherein the electronic interface allows the customer to establish and access an account with the enhanced refund processing server and provide the refund processing server with transactional access to one or more asset accounts owned by the customer, including at least one cryptocurrency wallet of the customer;
c. receiving at the merchant transaction server, via said data transmission network, an electronic authorization approved by a participating merchant specifying the customer, confirming a value to be refunded, and requesting one of a plurality of forms of refund selected by the customer;
d. selectively processing the requested refund based on the requested form of refund, such that if the requested form of refund is a credit of fiat currency to account of the customer, the refund is processed by the merchant transaction server, and if the customer has requested a refund in one or more other forms that include at least one type of cryptocurrency, the merchant transaction server instead transmits a message to the enhanced refund processing server identifying the customer, the value to be refunded, and the form of cryptocurrency in which the customer wishes to receive said value;
wherein said enhanced refund processing server, in response to said message transmitted by the merchant transaction server requesting a refund other than by credit of fiat currency to an account,
(1) electronically retrieves information for said at least one cryptocurrency wallet of the customer and transmits an instruction to transfer cryptocurrency to said customer cryptocurrency wallet by transmitting cryptocurrency transaction data via a network to at least one node maintaining a distributed ledger for the selected cryptocurrency,
(2) charges the merchant that authorized the refund, and
(3) transmits a confirmation to the merchant transaction server that the value represented by the authorized refund has been transferred to the customer's account.

18. The process of claim 17, wherein:
said one or more asset accounts owned by the customer include a securities brokerage account of the customer,
the merchant transaction server transmits a message to the enhanced refund processing server identifying the customer, the value to be refunded, and a form of security in which the customer wishes to receive said value; and
wherein said enhanced refund processing server, in response to said message transmitted by the merchant transaction server, electronically retrieves information for said securities brokerage account of the customer and transmits an instruction to transfer funds to said securities brokerage account, and transmits a confirmation to the merchant transaction server that the value represented by the authorized refund has been transferred to the customer's securities brokerage account.

19. The process of claim 17, wherein:
said one or more asset accounts owned by the customer include an electronic account of the customer for holding commercial paper assets;
the merchant transaction server transmits a message to the enhanced refund processing server identifying the customer, the value to be refunded, and a form of commercial paper in which the customer wishes to receive said value; and
wherein said enhanced refund processing server, in response to said message transmitted by the merchant transaction server, electronically retrieves information for said commercial paper account of the customer and transmits an instruction to transfer funds to said commercial paper account, and transmits a confirmation to the merchant transaction server that the value represented by the authorized refund has been transferred to the customer's commercial paper account.

20. The process of claim 17 wherein the customer preselects a non-fiat-currency asset for the refund via a web browser interface to the enhanced refund processing server.

21. The process of claim 17 wherein the customer selects a non-fiat-currency asset for the refund via a merchant point of sale terminal.

22. The process of claim 17 wherein the structure of the merchant transaction server comprises a credit card transaction processing server operated by a credit card issuer.

23. A process for electronically enabling an optional customer purchase of a non-fiat-currency asset, authorized by the customer while completing a merchant payment transaction, comprising the steps of:
a. providing an electronic enhanced debit processing server, connected via a data transmission network to a merchant transaction server that processes customer transactions for at least one merchant;
b. providing the customer with access to an electronic interface of the enhanced debit processing server, accessible via a data transmission network, wherein the electronic interface allows the customer to establish and access an account with the enhanced debit processing server and provide the debit processing server with transactional access to one or more asset accounts owned by the customer, including at least one cryptocurrency wallet of the customer;
c. receiving at the merchant transaction server, via said data transmission network, an electronic authorization approved by a participating merchant specifying the customer, confirming a value to be debited from a customer account and provided to the customer, and requesting one of a plurality of forms of receipt of that value selected by the customer;
d. selectively processing the requested debit based on the requested form of receipt, such that if the requested form of receipt is fiat currency, the debit is processed by the merchant transaction server, and if the customer has requested a debit to be delivered in one or more other forms that include purchase of at least one type of cryptocurrency, the merchant transaction server instead transmits a message to the enhanced debit processing server identifying the customer, the value to be debited, and the form of cryptocurrency in which the customer wishes to receive the debited amount;
wherein said enhanced debit processing server, in response to said message transmitted by the merchant transaction server requesting a debit to be delivered other than in fiat currency,
(1) electronically retrieves information for said at least one cryptocurrency wallet of the customer and transmits an instruction to transfer cryptocurrency to said customer cryptocurrency wallet by transmitting cryptocurrency transaction data via a network to at least one node maintaining a distributed ledger for the selected cryptocurrency, and
(2) transmits a confirmation to the merchant transaction server that the value represented by the authorized refund has been transferred to the customer's account.

24. The process of claim 23, wherein:
said one or more asset accounts owned by the customer include a securities brokerage account of the customer,
the merchant transaction server transmits a message to the enhanced debit processing server identifying the customer, the value to be delivered, and a form of security in which the customer wishes to receive said value; and
wherein said enhanced debit processing server, in response to said message transmitted by the merchant transaction server, electronically retrieves information for said securities brokerage account of the customer, transmits an instruction to deliver funds to said securities brokerage account, and transmits a confirmation to the merchant transaction server that the value represented by the authorized debit has been transferred to the customer's securities brokerage account.

25. The process of claim 23, wherein:
said one or more asset accounts owned by the customer include an electronic account of the customer for holding commercial paper assets;
the merchant transaction server transmits a message to the enhanced debit processing server identifying the customer, the value to be delivered, and a form of commercial paper in which the customer wishes to receive said value; and
wherein said enhanced refund processing server, in response to said message transmitted by the merchant transaction server, electronically retrieves information for said commercial paper account of the customer and transmits an instruction to transfer funds to said commercial paper account, and transmits a confirmation to the merchant transaction server that the value represented by the authorized debit has been transferred to the customer's commercial paper account.

26. The process of claim 23 wherein the customer preselects a non-fiat-currency asset for the refund via a web browser interface to the enhanced debit processing server.

27. The process of claim 23 wherein the customer selects a non-fiat-currency asset for the refund via a merchant point of sale terminal.

28. The process of claim 23 wherein the structure of the merchant transaction server comprises a credit card transaction processing server operated by a credit card issuer.
